(19) United States
(12) Patent Application Publication
(10) Pub. No.: US 2011/0153606 A1
(43) Pub. Date: Jun. 23, 2011

(54) APPARATUS AND METHOD OF MANAGING METADATA IN ASYMMETRIC DISTRIBUTED FILE SYSTEM

(75) Inventors: Hong-Yeon KIM, Daejeon (KR); Young-Kyun Kim, Daejeon (KR); Han Namgoong, Daejeon (KR)

(73) Assignee: Electronics and Telecommunications Research Institute, Daejeon (KR)

(21) Appl. No.: 12/970,900

(22) Filed: Dec. 16, 2010

(30) Foreign Application Priority Data
Dec. 18, 2009 (KR) 10-2009-0127530
Apr. 13, 2010 (KR) 10-2010-0033649

(51) Int. Cl. G06F 17/30

(52) U.S. Cl. 707/737; 707/E17.089

(57) ABSTRACT

Provided are an apparatus and a method which can be easily implemented with flexibility enabling distributing all metadata of trees and files in an asymmetric distributed file system. The apparatus includes: a metadata storage unit storing metadata corresponding to a part of partitions of a virtual metadata address space storing metadata for directories and/or files for each of the partitions; and a metadata storage management unit controlling the metadata so that the metadata are stored in the metadata storage unit and manages a master map including information on the part of the partitions. Since all directories and files can be distributed to a plurality of metadata servers without a limitation, it is possible to prevent a load from being concentrated on a predetermined metadata server. Metadata roles of the metadata servers are very simply readjusted and as a result, the load can be easily distributed in a partition level.

### CROSS-REFERENCE TO RELATED APPLICATION

This application claims the benefit of Korean Patent Application Nos. 10-2009-0127530, filed on Dec. 18, 2008 and 10-2010-0033649, filed on Apr. 13, 2010, in the Korean Intellectual Property Office, the disclosure of which is incorporated herein by reference.

### BACKGROUND OF THE INVENTION

1. Field of the Invention

The present invention relates to an apparatus and a method for controlling metadata in an asymmetric distributed file system, and more particularly, to an apparatus and a method for configuring and distributing a plurality of metadata servers depending on the capacity and performance of metadata required in an asymmetric distributed file system.

2. Description of the Related Art

An asymmetric distributed file system includes a metadata server processing all metadata, a plurality of data servers processing all data, and a plurality of file system clients for providing a file service by accessing the servers. The metadata server, the plurality of data servers, and the plurality of file system clients are connected to each other through a network.

The asymmetric distributed file system distributes and manages file data by configuring a large-sized data server pool of hundreds to thousands-of-units in order to PROVIDE high input/output performance and capacity for data. Metadata having a size smaller than data, such as a file name, a file size, other attributes, etc., is managed through one metadata server in most products. Therefore, in such a structure, a load to data is smoothly distributed to hundreds to thousands of data servers.

However, a load to metadata is concentrated on one metadata server which limits performance and extensibility. For example, in the case of Google FS and Hadoop DFS, the data server has the extensibility of hundreds to thousands of nodes. Contrary to this, the metadata server is administrated by one server or configured by an active/standby metadata server.

Even in Panasas which is the most technologically advanced in the file system having such a structure, the entire data server pool is divided into a plurality of volume units and the metadata server is just administrated for each volume. Even in this case, when a required metadata processing level for a predetermined volume is equal to or higher than the performance of one metadata server, there is no option but to divide the pool into the volumes.

### SUMMARY OF THE INVENTION

Several theses and patents make an attempt to divide a directory tree into a plurality of subtrees and distribute metadata in the level of the divided subtrees in a plurality of metadata servers. In another attempt, one metadata server takes charge of the directory tree and only metadata of individual files are distributed to the plurality of metadata servers.

However, in the subtree dividing scheme, the metadata server should be allocated for each subtree and the metadata server should be remastered by the unit of the subtree at the time of adding the metadata server. As such, flexible management is difficult. In addition, it is difficult to generalize the subtree dividing scheme due to implementation complexity.

Meanwhile, in the case of distributing only the metadata of the individual files, since the directory tree is not distributed, the implementation complexity is reduced and extreme flexibility is achieved for the individual files. However, in the case of distributing only the metadata of the individual files, there is a limit that the directory tree is managed by a single server or dual servers.

An aspect of the present invention provides an apparatus and a method which can be easily implemented with flexibility enabling distributing all metadata of trees and files at the time of administrating a plurality of metadata servers in an asymmetric distributed file system.

Specifically, another aspect of the present invention provides a very flexible apparatus and method which can arbitrarily divide a volume, a subtree, etc., into individual directories and file metadata which are atom-level metadata which cannot be divided any longer, not the unit of a set of a plurality of metadata and distribute the divided metadata into a plurality of metadata servers.

Yet another aspect of the present invention provides an apparatus and a method which can very intuitively and simply redistribute even when remastering of metadata between the metadata servers is required due to addition or removal of the metadata server.

Still another aspect of the present invention provides an apparatus and a method which can very simply maintain a map of a dividing state of metadata to easily identify a metadata server where metadata to be accessed is positioned.

An exemplary embodiment of the present invention provides an apparatus of managing metadata in an asymmetric distributed file system that includes: a metadata storage unit storing metadata corresponding to a part of the partitions of a virtual metadata address space storing metadata for directories and/or files for each of the partitions; and a metadata storage management unit controlling the metadata so that the metadata are stored in the metadata storage unit and manages a master map including information on the part of the partitions.

The master map is modified when the information on the part of the partitions is changed.

The master map includes a generation identifier for tracking modifications of the information on the part of the partitions.

The metadata storage management unit sends the master map to a client.

Each of the plurality of partitions includes a partition header block, a bitmap block, and at least one metadata block.

The bitmap block includes information representing allocation states of all blocks in the corresponding partition. The metadata block is any one of an inode block, a chunk layout block, and a directory entry block. The inode block stores a plurality of inodes which are the metadata for managing attribute information of the directories and files.

Each of the plurality of inodes is any one of a file inode including a block identifier array stored in the chunk layout block and a directory inode including a block identifier array stored in the directory entry block.

Another embodiment of the present invention provides an apparatus of managing metadata in an asymmetric distributed file system that includes: a first metadata server storing in a first metadata storage unit metadata corresponding to a part of partitions of a virtual metadata address space storing metadata for directories and/or files for each of the partitions; and a second metadata server storing in a second metadata storage unit metadata corresponding to other part of the partitions of the virtual metadata address space, wherein the first and second metadata servers includes a master map including information on the part of the partitions and information on the other part of the partitions.

Yet another embodiment of the present invention provides a method of managing metadata in an asymmetric distributed file system that includes: allowing a metadata server to be allocated with a part of partitions of a virtual metadata address space which is divided into a plurality of partitions and in which metadata for directories and/or files are stored for each of the partitions; allowing the metadata server to store the metadata of the part of the partitions; and allowing the metadata server to manage a master map including information on the part of the partitions.

The master map is modified when the information on the part of the partitions is changed.

The master map includes a generation identifier for tracking modifications of the information on the part of the partitions.

The method further includes allowing the metadata server to send the master map to a client.

Each of the plurality of partitions includes a partition header block, a bitmap block, and at least one metadata block.

The bitmap block includes information representing allocation states of all blocks in the corresponding partition. The metadata block is any one of an inode block, a chunk layout block, and a directory entry block. The inode block stores a plurality of inodes which are the metadata for managing attribute information of the directories and files.

Each of the plurality of inodes is any one of a file inode including a block identifier array stored in the chunk layout block and a directory inode including a block identifier array stored in the directory entry block.

According to the embodiments of the present invention, since all directories and files can be distributed to a plurality of metadata servers without limitation, it is possible to prevent a load from being concentrated on a predetermined metadata server.

Metadata roles of the metadata servers are very simply readjusted and as a result, the load can be easily distributed at a partition level. Role readjustment of the metadata server is completed by changing a master map and simply transmitting partition data having a fixed size to be moved to another metadata server. A volume and subtree-unit metadata server has a large advantage even though load distribution is limited to the unit of a volume and a subtree.

It is possible to very simply maintain the master map as metadata information which the metadata server takes charge of. The master map is constituted by only partition identifiers. The metadata server which is accessed through simple comparison of integers can be identified by acquiring the partition identifier from a metadata identifier, it is very simple to implement the master map and the execution efficiency of the master map is also very high.

### BRIEF DESCRIPTION OF THE DRAWINGS

FIG. 1 is a schematic configuration diagram of an asymmetric distributed file system according to an exemplary embodiment of the present invention;

FIG. 2 is a diagram specifically showing the configuration of FIG. 1;

FIG. 3 is a diagram for describing a virtual metadata address space according to an exemplary embodiment of the present invention;

FIG. 4 is a diagram for describing an identifier structure which enables identifying the block and the inode of FIG. 3;

FIG. 5 is a flowchart schematically illustrating a method for managing metadata in an asymmetric distributed file system according to an exemplary embodiment of the present invention;

FIG. 6 is a diagram showing an initial configuration example of a metadata server according to an exemplary embodiment of the present invention;

FIG. 7 is a diagram for describing an example in which a subdirectory is generated in a lower part of a root directory according to an exemplary embodiment of the present invention;

FIG. 8 is a diagram for describing an example in which a file is generated in a lower part of a subdirectory according to an exemplary embodiment of the present invention;

FIG. 9 is a diagram for describing an example in which a file is accessed in a lower part of a subdirectory according to an exemplary embodiment of the present invention; and

FIG. 10 is a diagram for describing a case in which a disk (metadata storage unit) is additionally mounted on a metadata server or a part of metadata servers are removed according to an exemplary embodiment of the present invention.

### DETAILED DESCRIPTION OF THE PREFERRED EMBODIMENTS

Hereinafter, an apparatus and a method of managing metadata in an asymmetric distributed file system according to the exemplary embodiments of the present invention will be described with reference to the accompanying drawings. The terms and words used in the present specification and claims should not be interpreted as being limited to typical meanings or dictionary definitions. Accordingly, embodiments disclosed in the specification and configurations shown in the accompanying drawings are just the most preferred embodiment, but are not limited to the spirit and scope of the present invention. Therefore, at this application time, it will be appreciated that various equivalents and modifications may be included within the spirit and scope of the present invention.

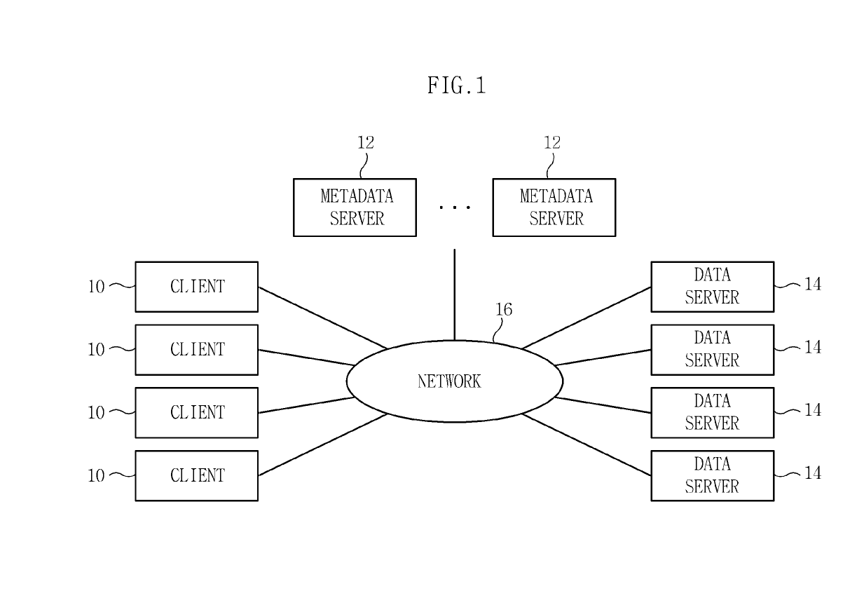

FIG. 1 is a schematic configuration diagram of an asymmetric distributed file system according to an exemplary embodiment of the present invention.

The asymmetric distributed file system according to the exemplary embodiment of the present invention includes a plurality of clients CLIENT 10, a plurality of metadata servers MDS 12, and a plurality of data servers DS 14 that are connected to each other on a network 16.

The metadata server 12 stores and manages various metadata used in the asymmetric distributed file system. The metadata server 12 includes a metadata storage in addition to a metadata processing module in order to store and manage the metadata. Herein, the metadata storage may be file systems ext2, ext3, and xfs and a database DBMS.

The data server 14 is a physical storage device connected to the network 16. The data server 14 inputs and outputs data as well as stores and manages actual data of a file.

In FIG. 1, the network 16 may be constituted by, for example, a local area network (LAN), a wide area network (WAN), a storage area network (SAN), a wireless network, etc. Of course, the network 16 may be a network enabling communication between hardware. In FIG. 1, the network 16 is used to communicate among the client 10, the metadata server 12, and the data server 14.

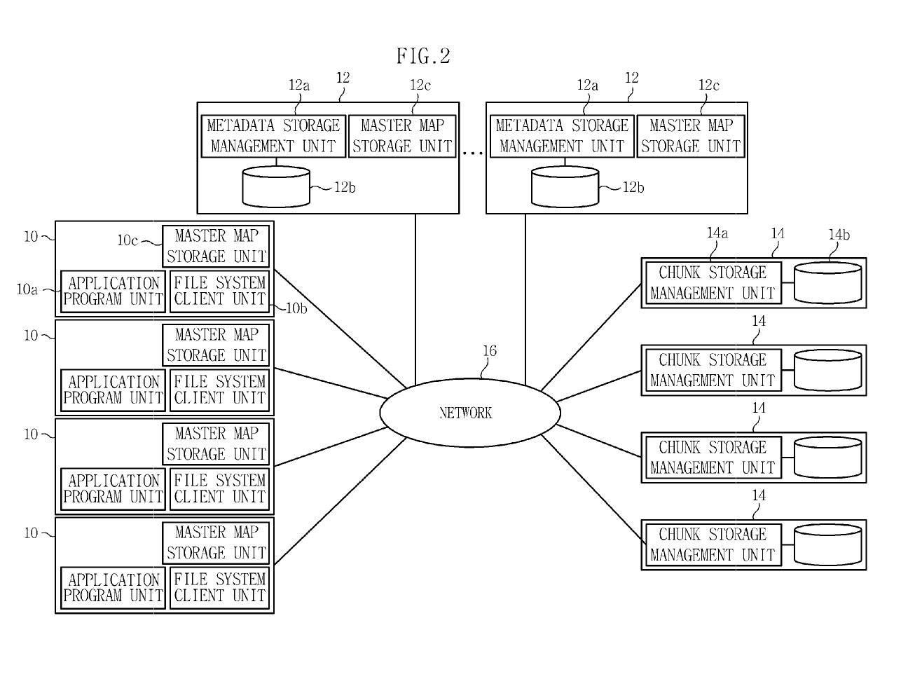

FIG. 2 is a diagram specifically showing the configuration of FIG. 1.

Each client 10 includes an application program unit 10a, a file system client unit 10b, and a master map storage unit 10c. The application program unit 10a can access the asymmetric distributed file system performed in the corresponding client 10. The file system client unit 10b provides a file system access interface (i.e., POSIX) for enabling the application program unit 10a to access the file stored in the asymmetric distributed file system. The master map storage part 10c stores a copy of a master map having information of the partition allocated for each metadata server.

Each metadata server 12 includes a metadata storage management unit 12a, a metadata storage unit 12b, and a master map storage unit 12c. The metadata storage management unit 12a stores the metadata in the metadata storage unit 12b. The metadata storage management unit 12a manages (i.e., modifies, removes, etc.) the metadata stored in the metadata storage unit 12b. The metadata storage unit 12b stores metadata corresponding to the allocated partitions (a part of the partitions) in a virtual metadata address space where metadata of a directory and a file are stored for each of the partitions. The metadata storage unit 12b may be, for example, the file systems such as ex2, ex3, xfs, etc., and the data base DBMS. The master map storage unit 12c stores a master map including information on the part of the partitions allocated to the corresponding metadata server 12 and information on other partitions allocated to another metadata server. The metadata storage management unit 12a controls the metadata so that the metadata are stored in the metadata storage unit 12b and manages the master map including information on the part of the partitions. Herein, the master map is a structure for tracking and managing metadata partitions allocated for each metadata server. The master map is modified when the information on the partitions allocated to the metadata server is modified. The master map additionally includes a generation identifier in order to easily track modifications. The generation identifier is increased by, for example, “1” whenever the master map is modified (including allocation, modification, removal, etc.). The master map is used to identify a metadata server storing metadata which the client 10 will access. Therefore, when the master map is modified in the metadata server, all the clients that are maintaining the copy of the master map should detect the modification of the master map. For this purpose, the generation identifier is utilized. The client 10 sends the generation identifier whenever accessing the metadata server 12. The metadata server 12 denies a request from the corresponding client 10 and notifies the modification of the generation identifier when the received generation identifier is smaller than a generation identifier of the original of the master map. As a result, the client 10 receives a newly updated master map from the corresponding metadata server 12.

In FIG. 2, although the metadata storage management unit 12a and the master map storage unit 12c are separately configured, the master map storage unit 12c may be incorporated in the metadata storage management unit 12a. In other words, the master map of the master map storage unit 12c of each metadata server 12 includes the information on the partitions allocated to another metadata server as well as the information on the partitions allocated to its own metadata server. Therefore, the master map storage unit 12c is not configured for each metadata server 12, but one master map storage unit 12c may be configured as one master map storage unit separately from the metadata server 12. That is, regardless of the configuration form of the master map, the master map should include all information on the partitions allocated for each metadata server 12.

Each metadata server 14 includes a chunk storage management unit 14a and a storage unit 14b. The chunk storage management unit 14a stores data transmitted from the client 10 in the storage unit 14b. The chunk storage management unit 14a manages (i.e., modifies, removes, etc.) data of the storage unit 14b.

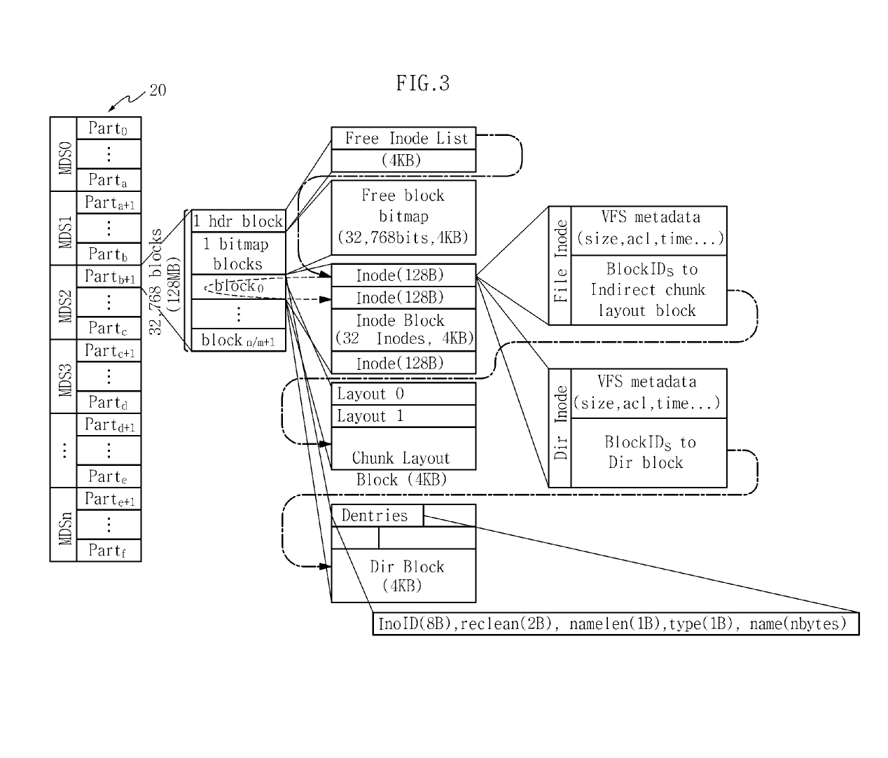

FIG. 3 is a diagram for describing a virtual metadata address space according to an exemplary embodiment of the present invention. FIG. 3 helps appreciating the administration of a metadata server. In the description of FIG. 3, reference numerals for the metadata servers are written as MDS0, MDS1, . . . , MDSn.

All metadata of the asymmetric distributed file system are disposed in a virtual metadata address space 20 having an address space of, for example, approximately 64 bits.

Each of the metadata servers MDS0 to MDSn identifies the maximum metadata volume which can be managed by the metadata server itself depending on the size of a hard disk (that is, metadata storage unit) mounted thereon. Each of the metadata servers MDS0 to MDSn is dynamically allocated with an address space as large as the identified size in the virtual metadata address space 20. The allocated unit is, for example, the unit of a partition having a size of 128 MB. Each of the metadata servers MDS0 to MDSn is allocated with several partitions which is receivable in a space allowed by the size of the mounted hard disk. The allocated virtual address space is not allocated to another metadata server. Referring to FIG. 2, it may be assumed that the maximum size of one metadata storage unit 12b is enough to store metadata recorded in one partition. As a result, in FIG. 3, a plurality of partitions are allocated for each of the metadata servers MDS0 to MDSn. This may be appreciated that each of the metadata servers MDS0 to MDSn includes a plurality of metadata storage units.

Each partition is divided into, for example, 32,768 blocks having the unit of 4 KB. The first block is used as a partition header block hdr block, the second block is used as bitmap blocks, and the rest of the blocks are used as metadata blocks blocks₀ to block_{n/m+1}.

The partition header block as a space for catalog information having the unit of the corresponding partition is formed by a free inode list. As necessary, various catalog information including an access time of the partition, the size of the partition, the number of inodes, the number of blocks, etc., may be added to the remaining space of the partition header block.

The bitmap block is used to track and manage a block allocation state in the partition. The bitmap block is a bit array displaying allocation state of all of the rest blocks other than the partition header block. The size of the bitmap block is approximately 4 KB. The size of the bitmap block is approximately 32,768 bits and manages states of blocks as many as the bitmap blocks. The size of the partition is fixed to 128 MB depending on the number of the blocks managed by the bitmap block.

The metadata block is utilized as any one of three types of an inode block, a chunk layout block, and a directory entry block. The inode block is used to store 32 inodes having a size of approximately 128 B. When the number of free inodes is short in the corresponding partition, the inode block is allocated with new blocks and initializes the allocated blocks to the inode blocks. When the new inode blocks are allocated, 32 new inodes are registered in the free inode list of the partition header. Herein, each inode is metadata for managing attribute information of directories and files. Each inode includes VFS common metadata such as the size, an access control acl, an owner, an access time, etc. Items to be included in the VFS common metadata are configured to conform to an attribute supported by an operating system. Each inode includes types of a file inode and a directory inode Dir Inode. The file inode additionally includes a block identifier array BlockIDs storing a chunk layout block. The directory inode additionally includes a block identifier array BlockIDs storing directory entries Dentries. The chunk layout block stores identifiers of chunks which are actual data of the files stored in the data server.

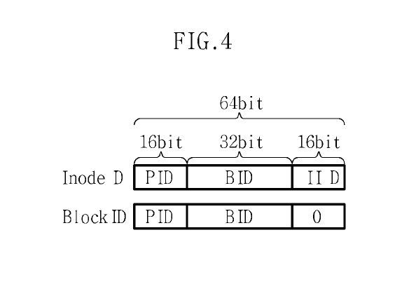

FIG. 4 is a diagram for describing an identifier structure which enables identification of the block and the inode of FIG. 3. That is, FIG. 4 shows an identifier structure which enables unique identification of an inode and a block in the entire virtual metadata address space. Each of the structures of the identifier InodelD and BlockID is configured with, for example 64 bits. Upper 16 bits display a partition number PID. Subsequent 32 bits display a block identifier BID. Subsequent 16 bits display an inode identifier IID in the block. When the identifier structure is used as the InodelD, all of the 64 bits are used. When the identifier structure is used as the block ID, lower 16 bits are not used and filled with 0 (zero).

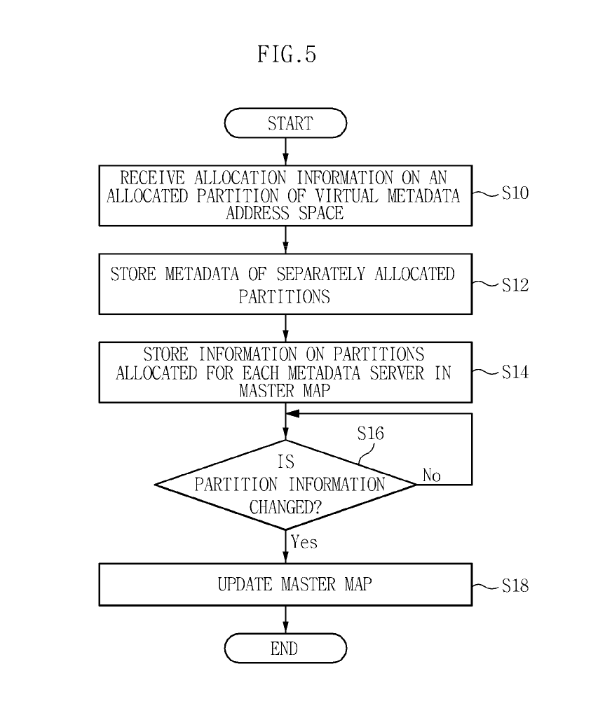

FIG. 5 is a flowchart schematically illustrating a method for managing metadata in an asymmetric distributed file system according to an exemplary embodiment of the present invention.

Metadata servers MDS0 to MDSn are independently (separately) allocated with a part of partitions of a virtual metadata address space (see FIG. 3) (S10). Each of the metadata servers MDS0 to MDSn identifies the maximum metadata volume which can be managed by the metadata server itself depending on the size of a metadata storage unit of each metadata server. Each of the metadata servers MDS0 to MDSn is dynamically allocated with predetermined partitions in the virtual metadata address space having an address space as large as the identified size in the virtual metadata address space. In this case, each metadata server receives allocation information on an allocated partition of a virtual metadata address space which is divided into a plurality of partitions and in which metadata for directories and/or files are stored for each of the partitions. The allocated partition corresponds to a part of the partitions. For example, in the embodiment of the present invention, partitions are allocated depending on the number of metadata storage units provided for each of the metadata servers MDS0 to MDSn. Since each of the metadata servers MDS0 to MDSn of FIG. 3 includes the plurality of metadata storage units, each metadata server is allocated with a plurality of partitions.

Subsequently, each of the metadata servers MDS0 to MDSn stores metadata of the separately allocated partitions in its own metadata storage unit (S12).

Each of the metadata servers MDS0 to MDSn stores information of the separately allocated partitions in a master map of its own master map storage unit (S14). Herein, the master map of each of the metadata servers MDS0 to MDSn stores even information of partitions allocated to another metadata server together. This is the same concept as a case in which all of the metadata servers MDS0 to MDSn share one master map. That is, the master map includes information of the partitions allocated for each of the metadata servers MDS0 to MDSn.

Thereafter, when the partition information allocated to the metadata servers MDS0 to MDSn is modified (“Yes” at step S16), the master map is updated (S18). In the update of the master map, master maps of other metadata servers as well as the master map of the corresponding metadata server are updated as the same content. This is for the plurality of metadata servers MDS0 to MDSn and the client 10 to share the master map having the same content. When the master map is modified, the master map is updated even in all clients 10 that maintain a copy of the master map. That is, the client 10 receives a newly updated master map from the corresponding metadata server 12.

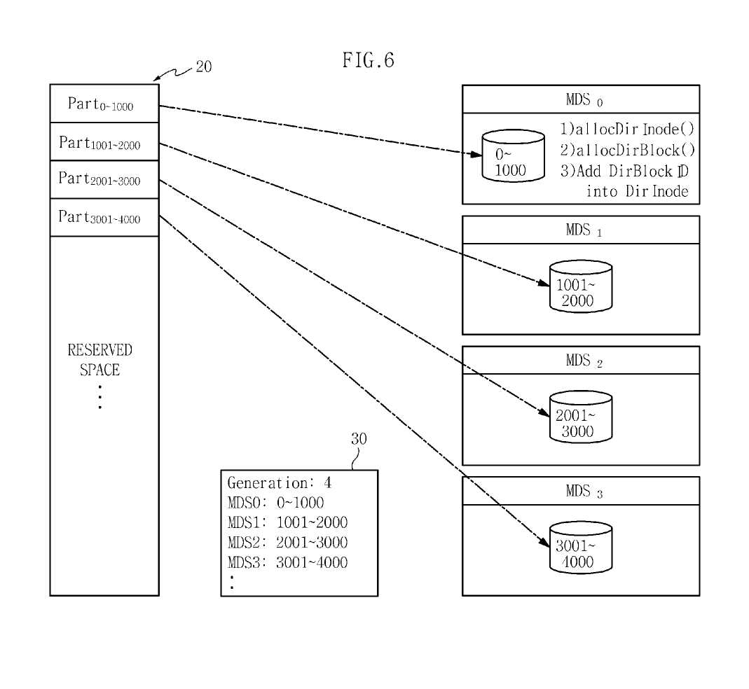

FIG. 6 is a diagram showing an initial configuration example of a metadata server according to an exemplary embodiment of the present invention and shows an initial configuration example of four metadata servers each having one 128-GB hard disk (that is, metadata storage unit).

1000 partitions (128 GB) are allocated to each of the metadata servers (i.e., MDS0, MDS1, MDS2, and MDS3) in a virtual metadata address space 20. The information is recorded in a master map 30. Herein, the master map 30 may be regarded as a master map in a mater map storage unit 12c provided for each of the metadata servers MDS0, MDS1, MDS2, and MDS3 (corresponding to the metadata server 12 of FIG. 2). On the other hand, the master map 30 may be regarded as a master map in a master map storage unit having a share concept which is configured separately from the metadata servers MDS0, MDS1, MDS2, and MDS3. A generation identifier of the master map 30 is increased from 0 (zero) to 4 by adding information of four partitions. The rest area in the virtual metadata space 20 is a reserved space which is not used. In addition, the metadata server MDS0 performs initialization for a root directory. In partition 0, the root directory is configured by allocating a directory inode and the directory block. In the exemplary embodiment of the present invention, the root directory inode is generated as the first inode of partition 0.

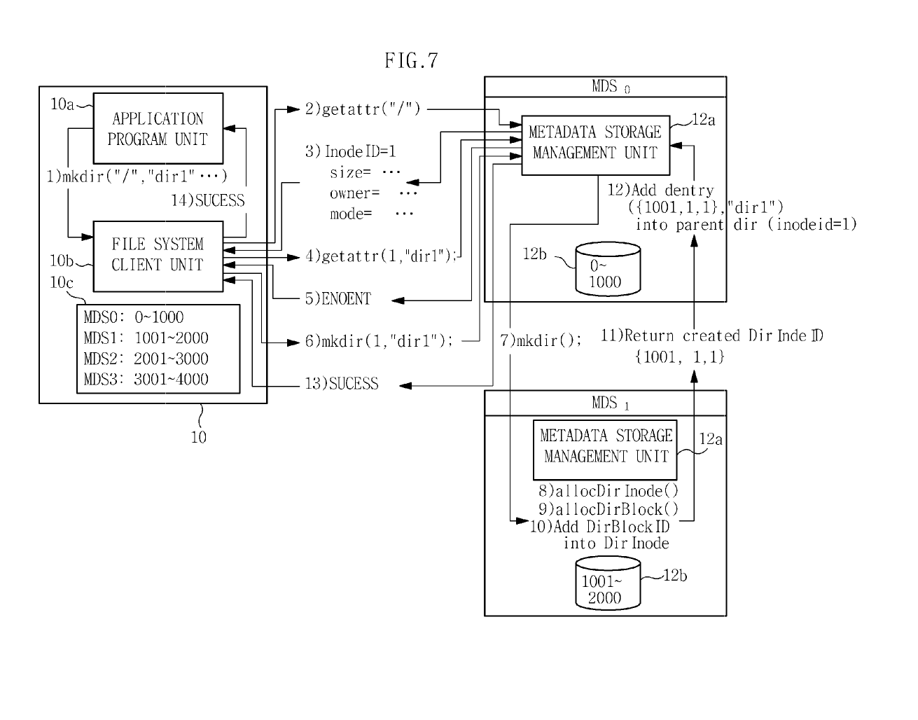

FIG. 7 is a diagram for describing an example in which a subdirectory is generated in a lower part of a root directory according to an exemplary embodiment of the present invention and shows an embodiment in which a ‘dir1’ directory is generated in the lower part of the root directory in an application program unit 10a.

First, the application program unit 10a of the client 10 receives and maintains the master map from any one metadata server.

Thereafter, when the application program unit 10a requests for generation of a directory to the file system client unit 10b (1 of FIG. 7), the file system client unit 10b determines a metadata server where the root directory is positioned through the master map in the master map storage unit 10c.

Subsequently, the file system client unit 10b acquires an attribute of the root directory from partition part0 of the metadata server MDS0 where the determined root directory is positioned (2 and 3 of FIG. 7).

The file system client unit 10b checks whether or not the directory dir1 to be generated in the root directory is already provided (4 and 5 of FIG. 7).

When the directory to be generated in the root directory is not provided according to the checking result, the file system client unit 10b delivers a request for actually generating ‘dir1’ in the partition part0 of the metadata server MDS0 storing the root directory (6 of FIG. 7).

The metadata server MDS0 receiving the directory generation request selects another metadata server MDS1 other than itself and delivers a subdirectory generation request to the metadata server MDS1 (7 of FIG. 7). Herein, the metadata server MDS0 selects another metadata server MDS1 in order to prevent all directories below a predetermined directory from being positioned at the same metadata server. By this configuration, the directories can be effectively distributed to all of the metadata severs. If the subdirectory is preferentially generated in the same metadata server as a parent directory, another subdirectory of the subdirectory will also be generated in the same metadata server. As a result, all directories in a lower part of a predetermined directory are concentrated on a single metadata server, as a result, a load is not effectively distributed.

The metadata server MDS1, which receives the request for generation of the subdirectory, generates an inode for the subdirectory (8 of FIG. 7).

Thereafter, the metadata server MDS1 allocates a block for storing entries of the subdirectory (9 of FIG. 7).

The metadata server MDS1 adds the allocated block identifier to the block identifier array of the directory inode to generate the directory InodeID (10 of FIG. 7).

The metadata server MDS1 returns the generated directory InodeID to the metadata server MDS0 (11 of FIG. 7).

The metadata server MDS0 adds the returned subdirectory identifier (directory InodeID) and the returned name of the subdirectory to the root directory (12 of FIG. 7).

The metadata server MDS0 returns ‘SUCCESS’ to the file system client unit 10b of the corresponding client 10 (13 of FIG. 7).

As a result, the file system client unit 10b returns ‘SUCCESS’ to the application program unit 10a (14 of FIG. 7).

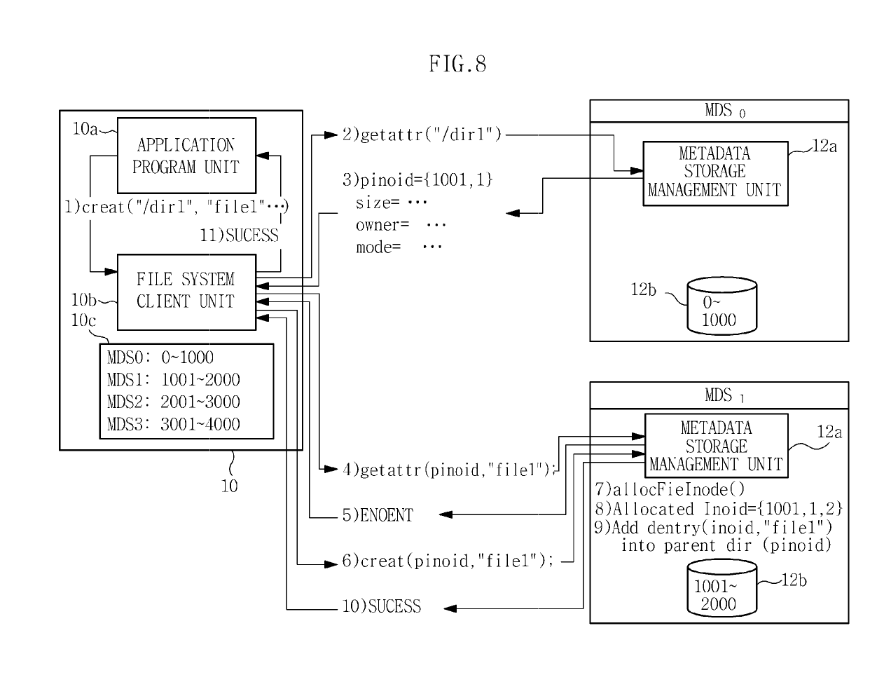

FIG. 8 is a diagram for describing an example in which a file is generated in a lower part of a subdirectory according to an exemplary embodiment of the present invention and shows an embodiment in which a ‘file1’ file is generated in a lower part of a “/dir1” directory in the application program unit 10a.

The application program unit 10a request generation of a file to the file system client unit 10b (1 of FIG. 8).

The file system client unit 10b acquires an attribute of the “dir1” directory from the partition part0 of the metadata server MDS0 where the root directory is positioned (2 and 3 of FIG. 8).

The file system client unit 10b which identifies that the “dir1” directory is positioned at a partition part1001 of the metadata server MDS1 from the InodeID checks whether or not a file to be generated in the “dir1” directory is already provided (4 and 5 of FIG. 8).

When the file system client unit 10b verifies that the corresponding file is not provided, the file system client unit 10b delivers a request for actually generating the ‘fuel” in the partition part1001 of the metadata server MDS1 (6 of FIG. 8).

The metadata server MDS1 which receives the file generation request generates an inode for the file in the partition part1001 which is the same partition as long as the space is large enough (7 of FIG. 8). Herein, the same metadata server MDS1 is selected in order to allow all files in the lower part of a predetermined directory to be positioned in the same metadata server as possible. By this configuration, the speed of file generation which occurs more frequently than generation of the directory and the retrieval performance of the directory are improved. If the files are preferentially generated in another metadata server other than the parent directory, the load is effectively distributed throughout all of the metadata servers. However, since two metadata servers participate whenever the file is generated, the performance is deteriorated. In the case of an application in which a file frequency is not high and the file access performance is more important, all of the metadata may be distributed throughout all of the metadata servers by generating the file in another metadata server other than the parent directory at all times in the same manner as generating the directory.

After step S7, the metadata server MDS1 allocates a block for storing a chunk layout (8 of FIG. 8).

The metadata server MDS1 adds the allocated block identifier to the block identifier array of the file inode (9 of FIG. 8).

Finally, the metadata server MDS1 returns ‘SUCCESS’ to the file system client unit 10b (10 of FIG. 8).

As a result, the file system client unit 10b returns ‘SUCCESS’ to the application program unit 10a (11 of FIG. 8).

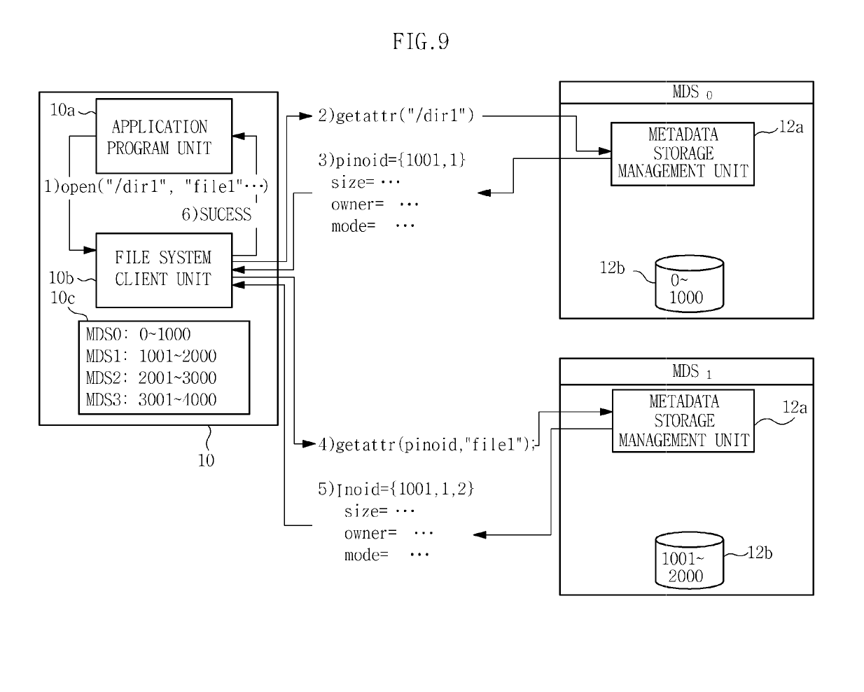

FIG. 9 is a diagram for describing an example in which a file is accessed in a lower part of a subdirectory according to an exemplary embodiment of the present invention and shows an embodiment in which a ‘file1’ file is accessed in a lower part of a “/dir1” directory in the application program unit 10a.

The application program unit 10a request access to the file to the file system client unit 10b (1 of FIG. 9).

The file system client unit 10b acquires the attribute of the “dir1” directory from the partition part0 of the metadata server MDS0 where the root directory is positioned (2 and 3 of FIG. 9).

The file system client unit 10b which identifies that the “dir1” directory is positioned at the partition part1001 of the metadata server MDS1 from the InodelD checks whether or not a file is provided in the “dir1” directory.

Thereafter, the file system client unit 10b accesses the “dir1” directory positioned in the partition part1001 of the metadata server MDS1 to acquire the attribute of the ‘file1’ (4 and 5 of FIG. 9).

The file system client unit 10b finally returns ‘SUCCESS’ to the application program unit 10a (6 of FIG. 9).

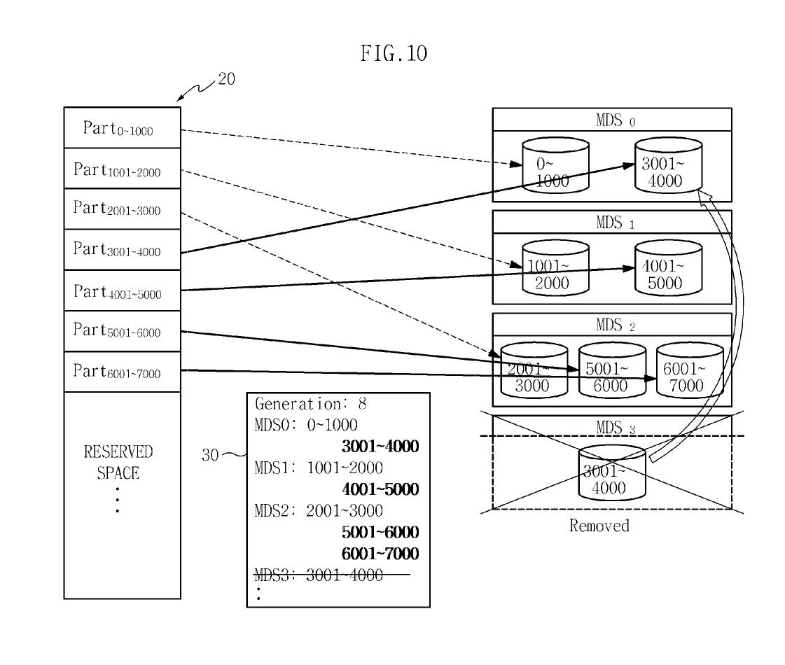

FIG. 10 is a diagram for describing a case in which a disk (metadata storage unit) is additionally mounted on a metadata server or a part of metadata servers are removed according to an exemplary embodiment of the present invention.

The disk may be additionally mounted on the existing metadata server MDS when a space of the hard disk to generate additional metadata is insufficient.

The metadata server MDS0 is transferred with a disk mounted on the metadata server MDS3 and mounted with the corresponding disk thereon. In this case, the metadata server MDS3 is removed. Moreover, in the master map, allocation information of partitions 3001 to 4000 is changed from the metadata server MDS3 to the metadata server MDS0.

The metadata servers MDS1 and MDS2 are mounted with additional disks thereon. In this case, new partitions 4001 to 5000, partitions 5001 to 6000, and partitions 6001 to 7000 are allocated depending on the capacity of the mounted disk in the virtual metadata address space 20 and recorded in the master map. As a result, the generation of the master map is increased from 4 to 8 in order to accumulate the number of modification times.

The present invention is not limited to the foregoing embodiments, but the embodiments may be configured by selectively combining all the embodiments or some of the embodiments so that various modifications can be made.

What is claimed is:

1. An apparatus of managing metadata in an asymmetric distributed file system, comprising:
a metadata storage unit storing metadata corresponding to a part of partitions of a virtual metadata address space storing metadata for directories and/or files for each of the partitions; and
a metadata storage management unit controlling the metadata so that the metadata are stored in the metadata storage unit and manages a master map including information on the part of the partitions.

2. The apparatus of claim 1, wherein the master map is updated when the information on the part of the partitions is changed.

3. The apparatus of claim 1, wherein the master map includes a generation identifier for tracking changes of the information on the part of the partitions.

4. The apparatus of claim 1, wherein the metadata storage management unit transmits the master map to a client.

5. The apparatus of claim 1, wherein the each of the plurality of partitions includes a partition header block, a bitmap block, and at least one metadata block.

6. The apparatus of claim 5, wherein the bitmap block includes information representing allocation states of all blocks in the corresponding partition.

7. The apparatus of claim 5, wherein the metadata block is any one of an inode block, a chunk layout block, and a directory entry block.

8. The apparatus of claim 7, wherein the inode block stores a plurality of inodes which are the metadata for managing attribute information of the directories and files.

9. The apparatus of claim 8, wherein each of the plurality of inodes is any one of a file inode including a block identifier array stored in the chunk layout block and a directory inode including a block identifier array stored in the directory entry block.

10. An apparatus of managing metadata in an asymmetric distributed file system, comprising:
a first metadata server storing metadata corresponding to a part of partitions of a virtual metadata address space storing metadata for directories and/or files for each of the partitions in a first metadata storage unit; and
a second metadata server storing metadata corresponding to other part of the partitions of the virtual metadata address space in a second metadata storage unit,
wherein the first and second metadata servers include a master map including information on the part of the partitions and information on the other part of the partitions.

11. A method of managing metadata in an asymmetric distributed file system, comprising:
receiving, by a metadata server, allocation information on an allocated partition of a virtual metadata address space which is divided into a plurality of partitions and in which metadata for directories and/or files are stored for each of the partitions, the allocated partition corresponding to a part of the partitions;
storing, by the metadata server the metadata of the allocated partition; and
managing, by the metadata server, a master map including information on the part of the partitions.

12. The method of claim 11, wherein the master map is updated when the information on the part of the partitions is changed.

13. The method of claim 11, wherein the master map includes a generation identifier for tracking modifications of the information on the part of the partitions.

14. The method of claim 11, further comprising sending, by the metadata server, the master map to a client.

15. The method of claim 11, wherein each of the plurality of partitions includes a partition header block, a bitmap block, and at least one metadata block.

16. The method of claim 15, wherein the bitmap block includes information representing allocation states of all blocks in the corresponding partition.

17. The method of claim 15, wherein the metadata block is any one of an inode block, a chunk layout block, and a directory entry block.

18. The method of claim 17, wherein the inode block stores a plurality of inodes which are the metadata for managing attribute information of the directories and files.

19. The method of claim 18, wherein each of the plurality of inodes is any one of a file inode including a block identifier array stored in the chunk layout block and a directory inode including a block identifier array stored in the directory entry block.
